(19) United States
(12) Patent Application Publication
(10) Pub. No.: US 2025/0178557 A1
(43) Pub. Date: Jun. 5, 2025

(54) Luftsack, vorzugsweise OPW-Luftsack, für ein Fahrzeug, Luftsackanordnung, Luftsackauslösevorrichtung und Verfahren zum Auslösen eines Luftsacks

(71) Applicant: Global Safety Textiles GmbH, Bad Säckingen (DE)

(72) Inventors: David Williamson, Lörrach (DE); Daniel Albiez, Murg (DE)

(21) Appl. No.: 18/948,684

(22) Filed: Nov. 15, 2024

(30) Foreign Application Priority Data
Nov. 24, 2023 (DE) 10 2023 132 908.1

(51) Int. Cl. B60R 21/231; B60R 21/235; D03D 1/02

(52) U.S. Cl. CPC B60R 21/23184; D03D 1/02; B60R 2021/23509; D10B 2505/124

(57) ABSTRACT

The invention relates to an airbag which is configured to be set from an uninflated state into an inflated state by an inflation operation to protect an occupant of a vehicle, the airbag comprising at least two fabric layers which are connected to one another in such a way that at least a first airbag chamber and a second airbag chamber being separate from the first airbag chamber are formed. According to the invention, it is further provided that the fabric layers are connected to one another so that the first airbag chamber and the second airbag chamber can be set independently of each other from the uninflated state thereof into the inflated state thereof, respectively, and the first airbag chamber, starting from uninflated state thereof, curves outwardly during a first inflation operation of the first airbag chamber and/or forms a tubular shape with an oval or circular cross-section at least in portions in the inflated state of the first airbag chamber, and thereby an overlapping portion, preferably an outer overlapping portion, of the second airbag chamber in the uninflated state thereof or in the inflated state thereof overlaps, preferably radially overlaps, an overlapping portion, preferably an inner overlapping portion, of the first airbag chamber.

The invention relates to an airbag, preferably an OPW airbag, for a vehicle, the OPW airbag being configured to be set from an uninflated state, for example a folded or collapsed state, to an inflated state, for example an unfolded state, in which the airbag can achieve its protective effect for the occupant, in order to protect an occupant of the vehicle, such as a motor vehicle or commercial vehicle, by means of an inflation operation.

Furthermore, the invention relates to an airbag arrangement comprising such an airbag and two independently operable or activatable gas generators.

Furthermore, the invention relates to an airbag deployment apparatus comprising a control apparatus and such an airbag arrangement as well as a method for deploying such an airbag arrangement.

Such airbags used in vehicles can be manufactured in different ways and are referred to as OPW airbags, Cut & Sew airbags or Cut, Seal & Sew airbags, for example, depending on the method of manufacture.

OPW airbags, so-called one-piece woven airbags, are airbags or airbags woven from one piece, while Cut & Sew airbags or Cut, Seal & Sew airbags are obtained by cutting several pieces of fabric, which may be glued and then sewn together.

Such airbags are widely used as part of vehicle restraint systems to protect vehicle occupants from collision with components of a vehicle structure such as a steering wheel, dashboard, door frame, etc.

Restraint systems in the form of airbag systems with such OPW airbags or airbags or with conventional airbags manufactured using the Cut & Sew or Cut, Seal & Sew process are actively activated if necessary and are widely known as active restraint systems in vehicles such as motor vehicles.

Airbags are designed differently depending on the type and location of use. Various types of airbags are known from the state of the art, for example in the form of driver and front passenger airbags, side airbags, far-side airbags, head airbags, knee airbags, window airbags, etc.

The so-called far-side airbags, also known as front-center airbags, are located in the driver's seat of motor vehicles on the side facing the front passenger, for example.

Front airbags such as driver or front passenger airbags, which are used for frontal impact protection, are usually installed on the vehicle's steering wheel in front of the driver or behind the instrument panel for the other occupants (front passengers) in the front seats.

In addition to frontal impact protection, airbags are also used to protect against side impacts. For example, the aforementioned side airbags, such as curtain airbags, side airbags in the seat or in the door trim, etc., are also provided. In particular, curtain airbags or special side airbags are thus generally fitted along roof side rails, i.e. the roof structure of the vehicle body, and deploy there to form an energy-absorbing structure between the head and upper torso of an occupant and the interior components of the vehicle.

In the event of an accident or imminent accident, a sensor fitted to the vehicle measures an abnormal deceleration of the vehicle. For example, gas is supplied to the airbag within a few milliseconds to set it from an uninflated state, i.e. folded or collapsed state, to an inflated state during an inflation operation. This is accomplished by a device such as a gas generator, commonly referred to as an “inflator”. The inflated airbag cushions the vehicle occupant from the impact forces.

In addition to the aforementioned OPW method, airbags are also often manufactured in a somewhat more complex way using the aforementioned Cut & Sew method or Cut, Seal & Sew method.

In particular, the Cut & Sew method only involves cutting pieces of fabric forming fabric layers to the desired shape, placing them on top of each other and sewing them together to form the airbag, the so-called Cut & Sew airbag.

Known airbags manufactured using the Cut, Seal & Sew method for this purpose are complex solutions and are produced with a high degree of manufacturing effort, for example by cutting out two or more identical or partially identical or different production parts from a flat fabric coated with silicone, spraying a sealing compound onto the edges—e.g. in the form of a circumferential bead—and then placing the two or more fabric parts on top of each other and then bonding the parts together. In addition, the fabric layers formed in this way are provided with a seam to ensure sufficient strength of the adhesive seam.

In the case of airbags manufactured using the Cut & Sew method and airbags manufactured using the Cut, Seal & Sew method, additional components, e.g. catch straps, flaps etc., sometimes also have to be sewn on in a further process step for shaping (with or without sealant).

The Cut & Sew method and the Cut, Seal & Sew method can therefore be more time-consuming and cost-intensive than the OPW method and often require numerous manual method steps.

In order to increase the protective effect of airbags, when designing airbags, especially in the area of frontal or side impact protection (e.g. driver airbag, passenger airbag, side airbag), for example, an approach is pursued to design the airbags with a larger contact surface or impact surface into which an occupant is impacted in the event of a vehicle collision. Hitherto, it has been known in the prior art to design the airbags with a higher airbag volume for this purpose. However, larger airbag volumes require larger gas generators and therefore inevitably more installation space in the vehicle, which is contrary to the design specifications for the airbag design.

Due to various influencing factors such as size, weight, seating position of the occupant, speed of the vehicle, impact angle of the occupant in relation to the airbag, it can be advantageous in the event of a crash or collision of the vehicle to achieve maximum protection for the occupant that an airbag has two or more stages with regard to its inflation height and is ignited or filled accordingly depending on the accident situation.

For this purpose, airbags are known from the state of the art which have two-stage inflation heights, i.e. they are inflated over two stages and their deployment is controlled via catch straps, etc. However, these can currently only be produced using highly complex processes. For example, complex and expensive catch band constructions are to be provided, which are cut with a so-called Pyro-Cutter, for example in the event of a collision, in order to then achieve a higher inflation height in a further stage or to control its running.

Such multi-stage airbags are used, for example, in adaptive restraint systems as so-called “adaptive airbags”, which can be deployed in several stages depending on the severity of the accident. Based on sensor data, for example by recording the influencing variables listed above, these can. “adaptive airbags” can be individually adapted to the occupant and the accident situation, i.e. such an adaptive airbag can automatically adjust both the internal pressure of the airbag and its geometry to the occupant size and other crash variables such as impact speed and seat position in the event of an accident; this can be done, for example, on the basis of sensor data and with the help of special catch straps, which can be used to individually adjust the airbag shape and the airbag working pressure to the respective occupant.

Known airbag designs with catch straps are manufactured according to the state of the art with only one airbag chamber, whereby a two-stage or multi-stage inflation height is realized by filling the airbag with different gas volumes. For example, in order to achieve an initial inflation height in a first stage, the airbag is filled with a corresponding volume of gas and deployment is controlled via the kinematic constraints imposed by the catch straps. In order to achieve a second or maximum inflation height in a second stage, the airbag is then further filled with a corresponding second volume of gas, with the catch straps continuing to control the further deployment of the airbag. If the maximum inflation height is to be achieved directly, the airbag is filled to the maximum in one step. Such well-known two-stage airbags have so far only been produced at great expense using the Cut & Sew technology described above.

However, it is problematic to optimally adjust the capacity of the gas generator to a corresponding two-stage airbag. For example, during an inflation operation to deploy the first or second stage, the airbag may be filled with insufficient or too much gas, resulting in an internal airbag pressure that is too low or too high, meaning that the specified internal airbag pressures are not achieved in the first or second stage. This can significantly reduce the protective effect of the airbag in the event of a crash or collision.

It is thus an object of the invention to provide an airbag, preferably an OPW airbag, an airbag arrangement, an airbag deployment apparatus and a corresponding deployment method, which at least partially avoids or at least diminishes the disadvantages known from the prior art; preferably, the invention is intended to provide a multi-stage airbag which can achieve an adequate protective effect.

That object is achieved by an airbag according to claim 1, an airbag arrangement according to claim 10, an airbag deployment apparatus according to claim 11 and a method for deploying an airbag arrangement according to claim 12.

Further advantageous embodiments and modifications of the invention are apparent from the dependent claims.

The airbag according to the invention is preferably a woven OPW airbag and is configured to be set, by an inflation operation, to protect an occupant of a vehicle from an uninflated state, for example a folded or collapsed state, to an inflated state, in which the airbag can develop its intended protective effect for the occupant, wherein the airbag has at least two fabric layers, preferably two fabric layers in certain regions and/or three fabric layers in certain regions, which are connected to one another in such a way that at least a first airbag chamber and an airbag chamber, separate from the first airbag chamber, i.e. the second airbag chamber not being fluidically connected to the first airbag chamber, are formed, wherein the fabric layers are furthermore connected to one another in such a way that
the first, preferably three-layered, airbag chamber and the second, preferably two-layered or three-layered, airbag chamber can be set independently of one another from their respective uninflated state into their respective inflated state, and
the first airbag chamber, starting from its uninflated state, curves outwardly during a first inflation operation of the first airbag chamber and/or forms a tubular shape with an oval or circular cross-section at least in portions in the inflated state of the first airbag chamber, and thereby an overlapping portion, preferably an outer overlapping portion, of the second airbag chamber in the uninflated state thereof or in the inflated state thereof overlaps, preferably radially overlaps, an overlapping portion, preferably an inner overlapping portion, of the first airbag chamber.

According to the invention, an OPW airbag with a two-stage inflation height can thus be implemented, which is preferably used as a front airbag in the vehicle.

The first stage is implemented, for example, by placing the first airbag chamber in its inflated state, while the second airbag chamber is left in its uninflated state. The inflation height of the airbag is thus largely determined by the first airbag chamber in the inflated state, which has a tubular shape with an oval or circular cross-section. Although the overlapping portion of the second airbag chamber overlaps the overlapping portion of the first airbag chamber in this state, it does not contribute significantly to the inflation height of the airbag. The second stage is implemented, for example, by placing both airbag chambers in the inflated state. Accordingly, the overlapping portion of the second airbag chamber leads to a further increase in the inflation height of the airbag.

The automated OPW production process eliminates the need for complex sewing operations that would be necessary for airbags manufactured using the Cut & Sew method. The inflation heights of the different inflation stages can be produced with greater differences in inflation height than with the solutions known so far.

In other words, the airbag can be manufactured with different chamber volumes of the respective airbag chambers, which can also have very different filling volumes. Since the embodiment of the airbag according to the invention has at least two airbag chambers that can be filled separately from one another, gas generators adapted to the respective chamber volume or filling volume of the respective airbag chamber can be used, whereby the respective optimum internal pressure can be generated in the respective airbag chamber.

The use of two separate or different gas generators, instead of one very large gas generator, can be advantageous in terms of generator type selection, as a specific gas generator can be selected for a particular airbag chamber and its special properties. This enables, for example, faster filling times, different release times and, due to the two separate gas sources, different internal pressures in the respective airbag chambers. There are also alternative installation options for the two gas generators, as two smaller gas generators can be used instead of one large gas generator in terms of the respective dimensions, for example.

The OPW airbag overlaps the respective overlapping portions of the first and second airbag chambers at a defined or predetermined point, whereby when a second gas generator is deployed to fill the second airbag chamber, a further inflation height or further stage of the airbag is achieved, predominantly at the predetermined point where the overlapping portions are located.

Thus, when the first stage is deployed, the airbag can have a first inflation height which is formed by a sum of a diameter of the first airbag chamber in its inflated state and the thickness of the overlapping portion of the second airbag chamber in its uninflated state.

Furthermore, when the second stage is deployed, the airbag can have a second inflation height, which is formed by a sum of a diameter of the first airbag chamber in its inflated state and the thickness of the overlapping portion of the second airbag chamber in its inflated state.

In particular, the region of the airbag at which the two overlapping portions are arranged, i.e. at which a portion of the first airbag chamber and a portion of the second airbag chamber lie on top of one another or overlap in cross-section as seen in the inflated state of the first airbag chamber, forms a variable region which determines the first inflation height and the second inflation height.

As the diameter of the first airbag chamber in its inflated state, in case of a ring-shaped cross-section there can be used the outer diameter of the ring-shaped cross-section, the inner diameter of the ring-shaped cross-section, or an average diameter formed from the inner and outer diameters.

On the other hand, in the case of an oval or elliptical cross-section of the first airbag chamber in its inflated state, the large or small semi-axis (of the ellipse) or a value derived therefrom can be taken into consideration.

The deployment can be controlled depending on the accident conditions, i.e. the second gas generator is only deployed to fill the second airbag chamber when required.

The respective airbag chambers form a kind of hollow cylinder shell and also lie in portions on top of each other or overlap, namely in their overlapping portions, but can be filled separately or independently of each other and are therefore not connected to each other in terms of flow, whereby a corresponding filling pressure and a corresponding filling time can be achieved depending on the design of the respective airbag chamber and selection of the respective gas generator.

The airbag according to the invention can be further formed in such a way that the fabric layers are connected or woven together in such a way that the outer overlapping portion of the second air bag chamber in the uninflated state overlaps radially the inner overlapping portion of the first air bag chamber in the inflated state and/or curves outwardly during a second inflation operation of the second air bag chamber or extends along the inner overlapping portion of the first air bag chamber in the inflated state and thereby radially overlaps the inner overlapping portion of the first air bag chamber in the inflated state and/or forms a radially outer tube wall portion or hollow cylinder wall portion with respect to the radially inner overlapping portion of the first air bag chamber in the inflated state.

In the fully inflated state of the airbag, i.e. when both the first airbag chamber and the second airbag chamber are completely filled with gas or air, the airbag is thus in the form of a tube with a circular ring-shaped or oval cross-section, the two overlapping portions forming a wall portion with a greater tube wall thickness compared to the remaining wall portions of the tube when viewed in cross-section. The two overlapping portions are also in contact with each other.

Preferably or optionally, the overlapping portions can be joined together, for example sewn, namely at a point at which the overlapping of both overlapping portions begins and at another point at which the overlapping of both overlapping portions ends.

Furthermore, the airbag according to the invention can be realized in such a way that the first airbag chamber has a plurality of (fluidically) interconnected first longitudinal airbag chambers with respective first (identical or different) airbag chamber volumes which, in the inflated state, are arranged next to one another in the circumferential direction and/or extend axially, transversely, obliquely or helically, and/or the second airbag chamber has a single longitudinal airbag chamber or a plurality of (fluidically) interconnected second longitudinal airbag chambers with respective second (identical or different) airbag chamber volumes which, in the inflated state, are arranged next to one another in the circumferential direction and/or extend axially, transversely, obliquely or helically, extend axially, transversely, obliquely or helically and/or the plurality of/group of the first longitudinal airbag chambers is arranged in circumferential direction next to the single longitudinal airbag chamber or the plurality of/group of the second longitudinal airbag chambers.

Preferably, a depth direction of the airbag in the inflated state corresponds to an axial direction of the tube or hollow cylinder thus formed. For example, the longitudinal airbag chambers thus extend transversely, i.e. at right angles, to the depth direction or axial direction of the tube in the circumferential direction thereof and can thus take the form of a circular ring or circular ring segment. If the longitudinal airbag chambers are parallel to the depth direction or axial direction of the tube, they run, for example, in the form of elongated tubes in the longitudinal direction of the tube/hollow cylinder and are preferably distributed or offset in the circumferential direction around the tube/hollow cylinder.

Another embodiment of the longitudinal airbag chambers is when they run at an angle to the depth direction, i.e. their direction of extension runs both in the axial direction and in the circumferential direction. For example, a tubular chamber designed in this way takes the form of a helix, i.e. a helical line or cylindrical spiral that describes a curve that winds with a constant pitch around the shell of a cylinder, i.e. in this case the hollow cylinder, by a certain angle.

Similarly, embodiments of the airbag are conceivable in which the multiple longitudinal airbag chambers are arranged one behind the other in the direction in which they extend, for example longitudinal airbag chambers arranged one behind the other parallel to the depth direction or longitudinal airbag chambers arranged one behind the other transversely to the depth direction and in the circumferential direction. The respective longitudinal airbag chambers arranged one behind the other are spatially separated from each other by respective seam sections, but are in fluid connection with each other.

Furthermore, the airbag according to the invention can be designed such that the first airbag chamber volumes of the first longitudinal airbag chambers are smaller, equal to or larger than the second airbag chamber volumes of the second longitudinal airbag chambers.

Furthermore, the airbag according to the invention can be implemented in such a way that the first longitudinal airbag chambers and/or the second longitudinal airbag chambers are tubular or at least in portions hollow cylindrical or in the shape of an elliptical hollow cylinder. In connection with the first and second longitudinal airbag chambers, tubular means, among other things, that these form an elongated hollow body with any desired cross-section, in particular with a circular, oval, semi-circular or rectangular cross-section.

Moreover, the airbag according to the invention can be realized in such a way that the airbag has, at least in portions, three fabric layers, namely a first fabric layer, a second fabric layer and a third fabric layer, the second fabric layer being arranged between the first fabric layer and the third fabric layer.

Preferably, the first fabric layer forms a lower fabric layer or a fabric layer forming an inner shell of the airbag, the second fabric layer forms a middle fabric layer or a fabric layer arranged at least in portions inside the airbag, and the third fabric layer forms an upper fabric layer or a fabric layer forming an outer shell of the airbag. Thereby, the three fabric layers are woven together in such a way that in a region forming the first airbag chamber there are formed between the first fabric layer and the second fabric layer and the third fabric layer and the second fabric layer first longitudinal airbag chambers extending in the axial direction and offset radially relative to one another and/or in a region forming the second airbag chamber there are formed between the first fabric layer and the second fabric layer and the third fabric layer and the second fabric layer second longitudinal airbag chambers extending in the axial direction and offset radially relative to one another, which, during their respective inflation operations, cause an outward curvature at least in portions.

Furthermore, the airbag according to the invention can be implemented in such a way that the airbag has three fabric layers at least in portions, namely a lower or first fabric layer, an upper or third fabric layer and a middle or second fabric layer arranged therebetween, the three fabric layers being woven together in such a way that in a region forming the first airbag chamber, first longitudinal airbag chambers extending in the axial direction and radially offset relative to one another are formed between the first fabric layer and the second fabric layer and the third fabric layer and the second fabric layer, while only two fabric layers in a region forming the second airbag chamber form one or more second longitudinal airbag chambers extending in the axial direction between the first fabric layer and the third fabric layer.

In addition, the air bag according to the invention can be designed in such a way that the first air bag chamber is connected to a region which forms a first generator mouth for receiving a first gas generator or a first connection region for connecting a first gas generator, and the second air bag chamber is connected to a region which forms a second generator mouth separate from the first generator mouth for receiving a second gas generator or a second connection region for connecting a second gas generator, so that the first airbag chamber and the second airbag chamber can be inflated independently of one another via the respective first or second gas generator.

Furthermore, the airbag according to the invention can be further formed in such a way that the airbag is configured as an OPW airbag with warp threads and weft threads which are woven into the woven fabric layers,
wherein the warp threads and weft threads are woven together in such a way that the airbag has a first partial region and a second partial region as well as a region forming the first airbag chambers, wherein the first partial region is arranged between the region forming the first airbag chambers and the second partial region,
wherein the warp threads and weft threads in the second partial region are woven together in such a way that the second partial region has at least one generator mouth for receiving a gas generator for filling the airbag or a connection for connecting a generator and is formed in two layers,
wherein the warp threads and weft threads in the region forming the first airbag chambers are woven together in such a way that the region forming the first airbag chambers comprises the plurality of first airbag chambers and is formed in three layers, and
wherein the warp threads and weft threads of the second fabric layer emerge from the second fabric layer in the first partial region and float completely between the first fabric layer and the third fabric layer and are incorporated into the first fabric layer and/or into the third fabric layer in the second partial region.

Thus, the first fabric layer and third fabric layer in the second partial region have the warp threads and weft threads of the second fabric layer.

In an alternative embodiment, the warp and weft threads are woven differently from the embodiment described above, particularly in the first and second partial regions.

According to the alternative variant, the weft threads of the middle fabric layer emerge from the middle fabric layer in the first partial region of the airbag and are partially attached to the upper fabric layer and partially attached to the lower fabric layer, whereas the warp threads of the middle fabric layer emerge from the middle fabric layer in the first partial region of the airbag and float freely between the lower fabric layer and the upper fabric layer. In the second partial region, the weft threads and the warp threads of the middle fabric layer are incorporated into the lower fabric layer or into the upper fabric layer or attached to the lower fabric layer or to the upper fabric layer at a few attachment points.

Of course, the warp and weft directions and thus also the warp and weft threads can, in principle, be reversed in both designs.

The airbag arrangement according to the invention has the above-mentioned airbag according to the invention and at least two independently activatable gas generators, wherein a first generator of the two gas generators is accommodated or connected in the first generator mouth or the first connection area of the first airbag chamber and a second generator of the two gas generators is accommodated or connected in the second generator mouth or the second connection area of the second airbag chamber.

Preferably, the two gas generators are different gas generators, which are matched to the respective first and second airbag chambers with regard to their filling behavior (e.g. with regard to the deliverable gas volume flow) or are matched to respective first and second airbag chamber volumes. As a result, the properties and advantages explained in connection with the airbag according to the invention also apply to the airbag arrangement according to the invention in the same or a similar way, which is why reference is made to the corresponding explanations in connection with the airbag according to the invention in order to avoid repetition.

The airbag deployment apparatus according to the invention for deploying an airbag has a control apparatus and the airbag arrangement according to the invention, wherein the control apparatus is configured to activate the first generator for filling the first airbag chamber and is further configured to activate the second generator for filling the second airbag chamber when the first generator has already been activated and a predetermined condition has been met, preferably a predetermined time has elapsed. As a result, the properties and advantages explained in connection with the airbag according to the invention also apply to the airbag deployment apparatus according to the invention in the same or similar way, which is why reference is made to the corresponding explanations in connection with the airbag according to the invention in order to avoid repetition.

The method according to the invention for deploying the airbag arrangement according to the invention comprises the following steps:
activating the first generator to fill the first airbag chamber of the airbag, and
activating the second generator to fill the second airbag chamber of the airbag, at the same time or after the first generator has already been activated. As a result, the properties and advantages explained in connection with the airbag according to the invention also apply to the method according to the invention in the same or a similar way, which is why reference is made to the corresponding explanations in connection with the airbag according to the invention in order to avoid repetition.

Preferred embodiments of the invention are explained below by way of example with reference to the figures.

These show:

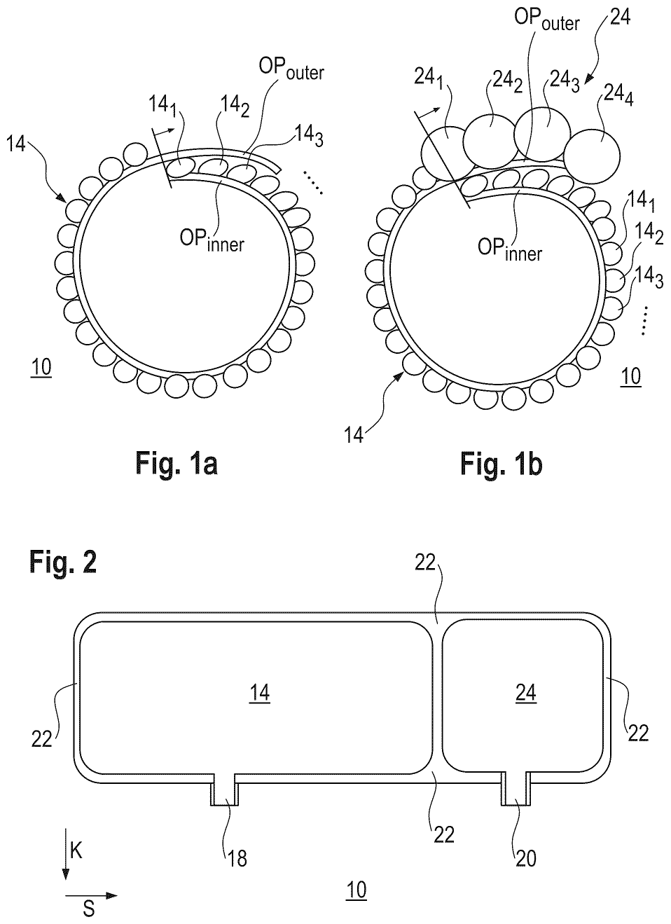

FIG. 1a) a schematic representation of an airbag according to a first embodiment of the invention in a cross-sectional view in a state in which a first airbag chamber is inflated and a second airbag chamber is uninflated;

FIG. 1b) a schematic representation of the airbag according to the invention of FIG. 1a) in a cross-sectional view in a state in which both the first airbag chamber is inflated and the second airbag chamber is inflated;

FIG. 2) a schematic representation of the airbag according to the invention of FIG. 1 a) in the deployed or spread-out state in a plan view;

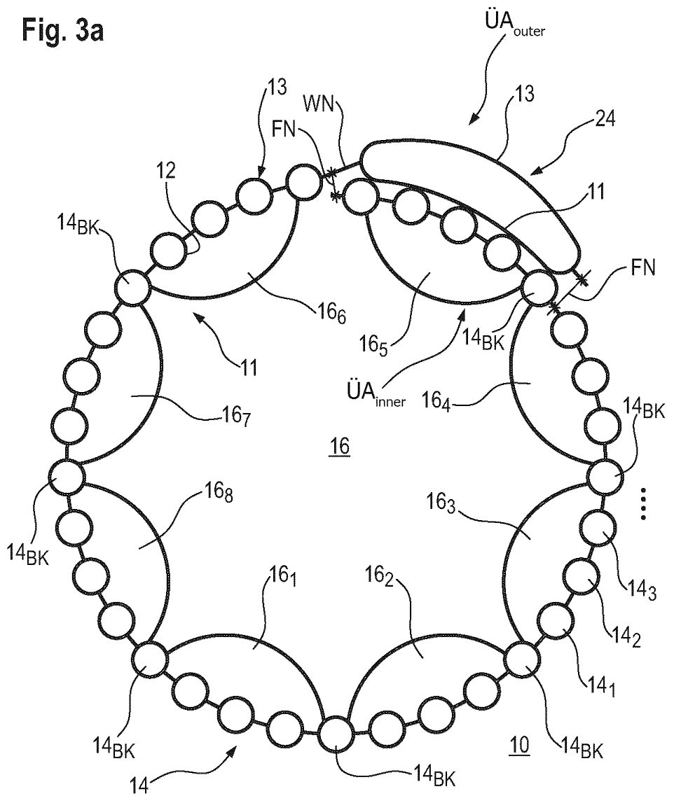

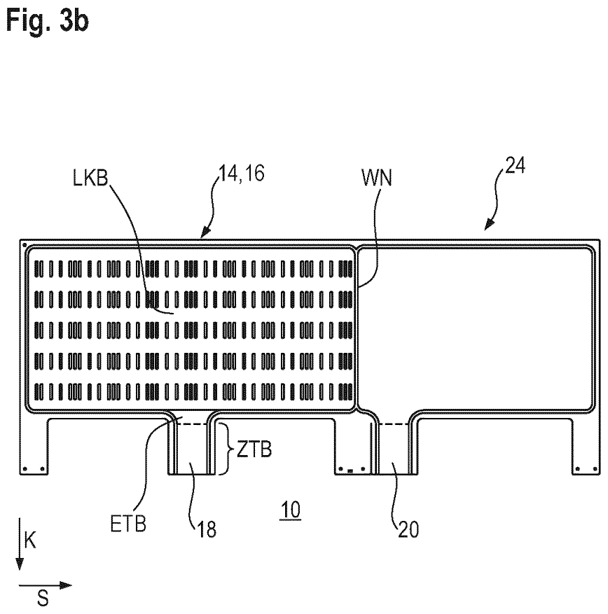

FIG. 3a) a schematic representation of an airbag according to the invention according to a second embodiment in a cross-sectional view in a state in which the first airbag chamber is inflated and the second airbag chamber is inflated with only a single second longitudinal airbag chamber;

FIG. 3b) a schematic representation of the airbag according to the invention of FIG. 3a) in the deployed or spread-out state in a plan view;

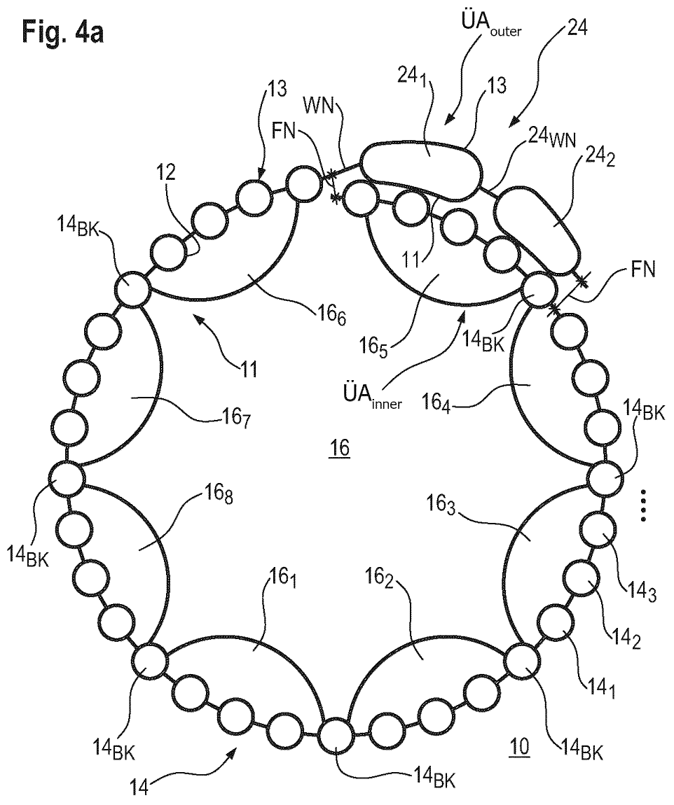

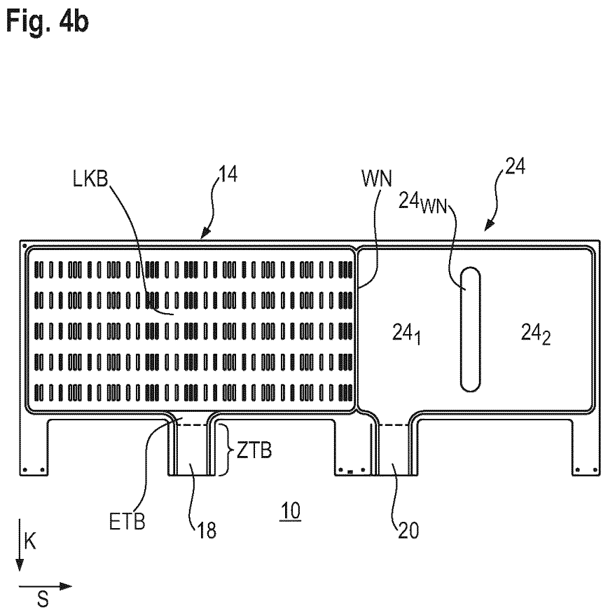

FIG. 4a) a schematic representation of an airbag according to the invention according to a third embodiment in a cross-sectional view in a state in which the first airbag chamber is inflated and the second airbag chamber is inflated with two second longitudinal airbag chambers;

FIG. 4b) a schematic representation of the airbag according to the invention of FIG. 4a) in the deployed or spread-out state in a plan view;

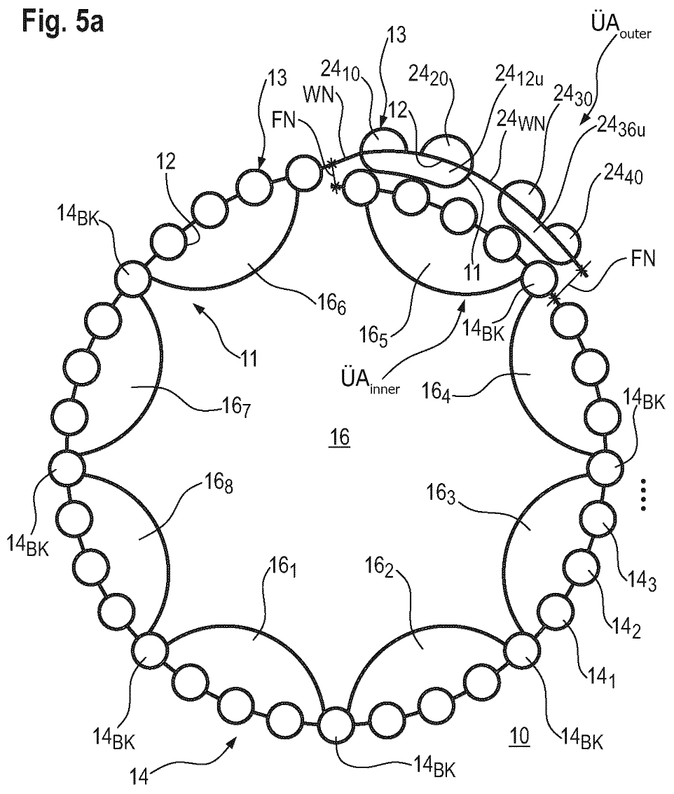

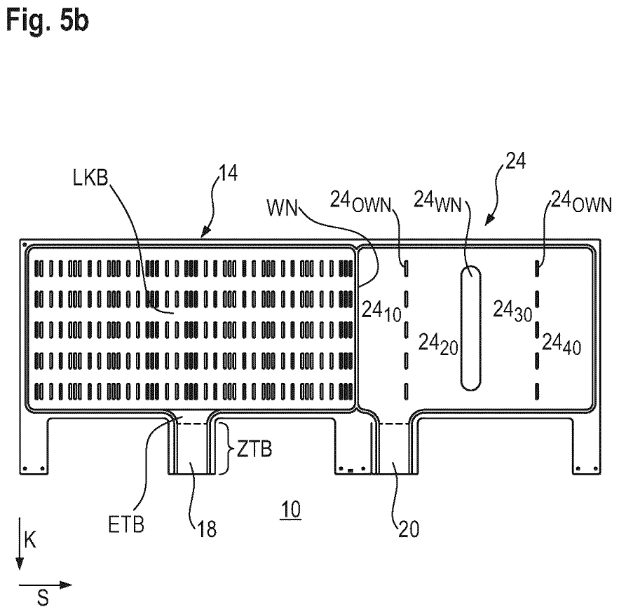

FIG. 5a) a schematic representation of an airbag according to the invention according to a fourth embodiment in a cross-sectional view in a state in which the first airbag chamber is inflated and the second airbag chamber is inflated with a plurality of second longitudinal airbag chambers;

FIG. 5b) a schematic top view of the airbag according to the invention of FIG. 5a) in the deployed or spread-out state.

In the embodiments shown in FIGS. 1 to 5, the airbag or gas bag 10 according to the invention is manufactured as an OPW airbag, i.e. it is a so-called “one piece woven” airbag 10, i.e. an airbag 10 woven in one piece.

In the specific application, the airbag 10 in this embodiment example is configured as a front airbag and is accordingly provided behind an instrument panel, not shown in detail, in front of the front passenger in a conventional manner not described in detail here. Alternatively, the airbag 10 according to the invention can also be used, for example, to protect occupants in the field of autonomous driving.

The airbag 10 according to the invention is configured to be set from an uninflated state, such as a folded or collapsed state, to an inflated state, in which the airbag can develop its protective effect for the occupant, in a conventional manner by means of an inflation operation in order to protect an occupant of a vehicle such as a motor vehicle or commercial vehicle. In other words, the airbag 10 is deployed from the uninflated state to the inflated state in the conventional manner in response to activation of an inflation device not shown in the figures, which in this case has two gas generators that are activated, for example, when a vehicle collision or similar is detected.

As shown only schematically in FIGS. 1 and 2, the airbag 10 has several fabric layers 11, 12, 13 for this purpose, which are explained in more detail below, with two fabric layers lying on top of one another in one or more regions of the airbag 10 and three fabric layers lying on top of one another in one or more regions, which will be discussed in more detail later.

The fabric layers 11, 12, 13 are connected to each other in such a way that in this case a first airbag chamber 14 (in detail first longitudinal airbag chambers 14₁, 14₂, 14₃) and a second airbag chamber 24 (in detail second longitudinal airbag chambers 24₁, 24₂, 24₃, 24₄) separate from the first airbag chamber 14 are formed. The first airbag chamber 14 and the second airbag chamber 24 are not connected to each other in terms of flow.

In other words, the airbag 10 is formed as an OPW airbag with warp threads running in the warp direction K and weft threads running in the weft direction S (see for example FIG. 2—warp and weft directions can alternatively be reversed), which are inserted into the woven fabric layers 11, 12, 13 to form the first airbag chamber 14 and the second airbag chamber 24, wherein a woven seam 22, in which the woven fabric layers 11, 12, 13 are combined to form a single layer, separates the first airbag chamber 14 and the second airbag chamber 24 from one another. Accordingly, the airbag 10 has first and second airbag chambers 14, 24 that can be filled independently of one another.

In this context, the fabric layers 11, 12, 13 are further connected with one another such that the first airbag chamber 14 is three-layered and the second airbag chamber 24 is preferably two-layered or alternatively three-layered, wherein the first and second airbag chambers 14, 24 can be moved independently of each other from their respective uninflated states to their respective inflated states.

Furthermore, the fabric layers 11, 12, 13 are connected to each other in such a way that the first airbag chamber 14, starting from its uninflated state, curves outwards during a first inflation operation of the first airbag chamber 14 and then forms, at least in portions, a tubular shape or hollow cylindrical shape with an essentially circular or oval cross-section in the inflated state of the first airbag chamber 14.

In this case, an outer overlapping portion ÜAₒᵤₜₑᵣ of the second airbag chamber 24 in its uninflated state or in its inflated state overlaps with inner overlapping portion ÜAᵢₙₙₑᵣ of the first airbag chamber 14 in the radial direction, as can be seen in particular in FIG. 1.

FIG. 1a) shows a schematic representation of the airbag 10 according to the invention according to the first embodiment in a cross-sectional view in a state in which the first airbag chamber 14 is inflated and the second airbag chamber 24 is uninflated, whereas FIG. 1b) shows a schematic representation of the airbag 10 according to the invention of FIG. 1a) in a cross-sectional view in a state in which both the first airbag chamber 14 and the second airbag chamber 24 are inflated. Furthermore, FIG. 2) shows a schematic representation of the airbag 10 according to the invention of FIG. 1 a) in the deployed or spread-out state in a plan view.

As can be seen further in FIGS. 1 and 2, the outer overlapping portion ÜAₒᵤₜₑᵣ Of the second airbag chamber 24, which is in the uninflated state, overlaps radially with the inner overlapping portion ÜAᵢₙₙₑᵣ of the first airbag chamber 14, which is in the inflated state (FIG. 1 a)). Furthermore, during a second inflation operation of the second airbag chamber 24, outer overlapping portion ÜAᵢₙₙₑᵣ curves outwards and extends along the inner overlapping portion ÜAᵢₙₙₑᵣ of the first airbag chamber 14 in the inflated state, radially overlapping with the inner overlapping portion ÜAᵢₙₙₑᵣ of the first airbag chamber 14 in the inflated state. As a result, the outer overlapping portion ÜAₒᵤₜₑᵣ forms a radially outer tube wall portion or hollow cylinder wall portion in relation to the radially inner overlapping portion ÜAᵢₙₙₑᵣ the first airbag chamber 14 in the inflated state.

As can be seen in FIG. 1 in particular and is indicated by an arrow, the overlapping portions ÜAₒᵤₜₑᵣ and ÜAₒᵤₜₑᵣ are defined as an area in which the first airbag chamber 14 and the second airbag chamber 16 overlap in the radial direction along the circumferential direction of the airbag.

As can also be seen in particular from FIGS. 1a) and 1b), the first airbag chamber 14 has a plurality of fluidically interconnected first longitudinal airbag chambers 14₁, 14₂, 14₃ with respective first airbag chamber volumes which, in the inflated state, are arranged next to one another in the circumferential direction and extend axially.

Furthermore, in this case, the second airbag chamber 24 has a plurality of interconnected second longitudinal airbag chambers 24₁, 24₂, 24₃, 24₄ with respective second airbag chamber volumes which, in the inflated state, are arranged next to each other in the circumferential direction and extend axially.

Moreover, it can be seen in FIGS. 1a) and 1b) that the plurality of or group of the first longitudinal airbag chambers 14₁, 14₂, 14₃ is arranged in circumferential direction next to the plurality of or group of the second longitudinal airbag chambers 24₁, 24₂, 24₃, 24₄. In this embodiment, the respective first airbag chamber volumes of the first longitudinal airbag chambers 14₁, 14₂, 14₃ are smaller than the respective second airbag chamber volumes of the second longitudinal airbag chambers 24₁, 24₂, 24₃, 24₄ with the same longitudinal extension (warp direction in FIG. 2).

Furthermore, it can be seen from FIGS. 1a) and 1b that the first longitudinal airbag chambers 14₁, 14₂, 14₃ and the second longitudinal airbag chambers 24₁, 24₂, 24₃, 24₄ are essentially hollow-cylindrical or in the form of an elliptical hollow cylinder.

In the deployed or spread-out state of the air bag 10 shown in FIG. 2, it can be seen that the air bag 10 in this state, i.e. with layers of fabric lying on top of each other, has an essentially rectangular shape, which essentially corresponds to the lateral surface of the hollow cylinder, the region with the first airbag chamber 14 is adjoined by a region with a first generator mouth 18 for receiving a first gas generator not shown here and the region of the second airbag chamber 24 is adjoined by a region with a second generator mouth 20 separate from the first generator mouth 18 for receiving a second gas generator not shown here, so that the first airbag chamber 14 and the second airbag chamber 24 can be inflated independently of one another via the respective first or second gas generator.

Together with two gas generators, which can be activated independently of one another and are not shown in this case, the airbag 10 forms an airbag arrangement according to the invention, wherein a first generator of the two gas generators is accommodated in the first generator mouth 18 and a second generator of the two gas generators is accommodated in the second generator mouth 20. The respective generators are designed differently with regard to their filling behavior. Thus, the first generator connected to the generator mouth 18 can generate a larger volume flow than the second generator connected to the generator mouth 20 if the first airbag chamber 14 has a larger volume than the second airbag chamber 24.

To activate the generators, a control apparatus not shown is provided in addition to the airbag arrangement, which together form an airbag deployment apparatus configured to deploy the airbag 10. The control apparatus not shown in this case is configured to activate the first generator to fill the first air chamber 14, and is further configured to activate the second generator to fill the second air chamber 24 if the first generator has already been activated and a predetermined condition has been met, which in this case is the elapse of a predetermined time. However, the control apparatus can also activate both generators simultaneously if necessary.

Accordingly, one mode of operation of the airbag arrangement, namely deploying the airbag arrangement, is as follows:

First, the first generator is activated to fill the first air chamber 14 of the airbag 10, whereby the first longitudinal airbag chambers 14₁, 14₂, 14₃ are set to their inflated state, thereby reaching the first stage of the inflation height of the airbag 10.

Subsequently, i.e. after a predetermined time has elapsed, or simultaneously, depending on the type of vehicle collision, for example the extent of the acceleration values detected, the second generator is activated to fill the second air chamber 24 of the airbag 10. This also fills the outer overlapping portion ÜAₒᵤₜₑᵣ of the second airbag chamber 24, whereby the second longitudinal airbag chambers 24₁, 24₂, 24₃, 24₄ arranged in the outer overlapping portion ÜAₒᵤₜₑᵣ are placed in their inflated state, thereby achieving the second stage of the inflation height of the airbag 10.

The basic structure of the airbag 10 has been described above.

In order to achieve the aforementioned chamber structure comprising the first airbag chamber 14 with its first longitudinal airbag chambers 14₁, 14₂, 14₃ and the second airbag chamber 24 with its second longitudinal airbag chambers 24₁, 24₂, 24₃, 24₄, the airbag 10 is structured from the aforementioned superimposed fabric layers 11, 12, 13, which specifically can be woven into three fabric layers in an area LKB of the airbag 10 forming the first airbag chamber 14 and can be woven into two or three fabric layers in another area forming the second airbag chamber 24.

The specific structure of the airbag 10 with regard to the chamber structure achieved by interweaving the respective fabric layers is explained in more detail with reference to the embodiments described below.

FIG. 3a) shows a schematic representation of an airbag 10 according to the invention according to a second embodiment in a cross-sectional view in a state in which the first airbag chamber 14, 16 is at least partially inflated with a plurality of longitudinal airbag chambers and the second airbag chamber 24 is at least partially inflated with a single longitudinal airbag chamber. FIG. 3b) shows a schematic top view of the airbag 10 according to the invention of FIG. 3a) in the deployed or spread-out state.

As can be seen from FIG. 3a and FIG. 3b, the airbag 10 has three fabric layers 11, 12, 13 in the region LKB forming the first airbag chamber 14, namely a lower or first fabric layer 11, an upper or third fabric layer 13 and a middle or second fabric layer 12 arranged therebetween, the three fabric layers 11, 12, 13 being interwoven in such a way that in the region LKB forming the first airbag chamber 14 the first longitudinal airbag chambers 14₁, 14₂, 14₃ und 16₁, 16₂, . . . , 16₈ extending in the axial direction and arranged next to one another in the circumferential direction are formed. In particular, the first (inner) longitudinal air bag chambers 16₁, 16₂, . . . , 16₈ are formed between the lower/inner fabric layer 11 and the middle fabric layer 12 and the first (outer) longitudinal air bag chambers 14₁, 14₂, 14₃, 14_{BK}, . . . are formed between the upper/outer fabric layer 13 and the middle fabric layer 12.

As can further be seen from FIG. 3a, the first (inner) longitudinal airbag chambers 16₁, 16₂, . . . , 16₈ are offset radially relative to the first (outer) longitudinal airbag chambers 14₁, 14₂, 14₃, 14_{BK}, . . . i.e. offset radially further inwards. In this embodiment example, three of the first (outer) longitudinal airbag chambers 14₁, 14₂, 14₃ are each radially covered by one of the first (outer) longitudinal airbag chambers 14₁, 14₂, 14₃, 14_{BK}, wherein a respective first (outer) longitudinal airbag chamber 14_{BK} (also called longitudinal airbag bridging chamber) connects two adjacent ones of the first (inner) longitudinal airbag chambers 16₁, 16₂, . . . , in circumferential direction.

On the basis of this chamber structure of the first inner and outer longitudinal airbag chambers 14₁, 14₂, 14₃ und 16₁, 16₂, . . . , 16₈, a very rigid and stable outwardly curved structure of the airbag 10 is created in the inflated state, which forms a hollow cylinder or tube with an almost circular ring-shaped or oval hollow cylinder cross-section.

As can also be seen in FIG. 3a), the fabric layers 11, 12, 13 are woven into a single woven seam WN in an intermediate region between the region LKB forming the first airbag chamber 14, 16 and the region forming the second airbag chamber 24, which in the region forming the second airbag chamber 24 again merges into two fabric layers 11 and 13, a lower/inner fabric layer 11 and an upper/outer fabric layer 13, which are woven together in such a way that in the region forming the second airbag chamber 24 the second airbag chamber 24 forms a single second longitudinal airbag chamber extending in the axial direction between the lower/inner fabric layer 11 and the upper/outer fabric layer 13. In this case, the region forming the second airbag chamber 24 with the second longitudinal airbag chamber forms the outer overlapping portion ÜAₒᵤₜₑᵣ while the radially more inwardly located portion of the region LKB forming the first airbag chamber 14, 16 forms the inner overlapping portion ÜAᵢₙₙₑᵣ, as indicated in FIG. 3a.

As can also be seen in FIG. 3a), a start and end of the outer overlapping portion ÜAₒᵤₜₑᵣ can optionally be connected to a start and end of the inner overlapping portion ÜAᵢₙₙₑᵣ, for example via a fixing seam FN, which is only schematically indicated. Among other things, this serves to stabilize the airbag 10 when both the first airbag chamber 14, 16 and the second airbag chamber 24 are placed in their inflated state.

As further illustrated in FIG. 3b, the airbag 10 has a first partial region ETB and a second partial region ZTB as well as a region LKB forming the first airbag chamber 14, wherein the first partial region ETB is arranged between the region LKB forming the first airbag chamber 14 and the second partial region ZTB.

The warp threads and weft threads in the second partial region ZTB are woven together in such a way that the second partial region ZTB forms the generator mouth 18 for receiving a gas generator for filling the airbag and is formed in two layers, the warp threads and weft threads in the region LKB forming the first airbag-forming chamber 14, 16 being woven together in such a way that this has the first airbag chamber 14, 16 and is formed in three layers. The warp threads and weft threads of the second fabric layer 12 emerge from the second fabric layer 12 in the first partial region ETB and float completely between the first fabric layer 11 and the third fabric layer 13 and are incorporated into the first fabric layer 11 or the third fabric layer 13 in the second partial region ZTB.

FIG. 4a) shows a schematic representation of an airbag 10 according to the invention according to a third embodiment in a cross-sectional view in a state in which the first airbag chamber 14, 16 is inflated and the second airbag chamber 24 is inflated with two second longitudinal airbag chambers 241 and 242. FIG. 4b) shows a schematic representation of the airbag 10 of the invention of FIG. 4a) in the deployed or spread-out state in a plan view. In the description of this third embodiment, in order to avoid repetition, only the differences to the second embodiment explained above are discussed, with the same or similar components being designated with the same reference signs.

In this embodiment example, the region forming the second airbag chamber 24 is formed in two layers, the fabric layers 11 and 13—as can be seen mainly in FIG. 4a —being woven together in such a way that two second longitudinal airbag chambers 24₁ und 24₂ are formed in the second region, which are arranged next to one another in the circumferential direction and are spaced apart from one another by a woven seam 24_{WN}.

FIG. 5a) shows a schematic representation of an airbag 10 according to the invention according to a fourth embodiment in a cross-sectional view in a state in which the first airbag chamber 14, 16 is inflated and the second airbag chamber 24 with a plurality of longitudinal airbag chambers is inflated. FIG. 5b) shows a schematic top view of the airbag 10 of FIG. 5a) according to the invention in the deployed or spread-out state. In the description of this fourth embodiment, in order to avoid repetition, only the differences to the second embodiment explained above are discussed, with the same or similar components being designated with the same reference signs.

In this embodiment example, the region forming the second airbag chamber 24 is formed in three layers, wherein—as it is mainly apparent from FIG. 5a—the fabric layers 11, 12 and 13 are woven together in such a way that four second upper longitudinal airbag chambers 24₁₀, 24₂₀, 24₃₀ and 24₄₀ arranged next to one another in the circumferential direction are formed in the second region, spaced apart by upper woven seams 24_{OWN}, and on the other side, in relation to the middle fabric layer, two second lower longitudinal airbag chambers 24₁₂ᵤ und 24₃₄ᵤ are formed which are arranged next to one another, are spaced apart from one another by a woven seam 24_{WN} and each cover two of the second upper longitudinal airbag chambers 24₁₀, 24₂₀, 24₃₀ and 24₄₀ in the radial direction.

The features of the invention which are disclosed in the above description, in the drawings and in the claims may be essential for implementing the invention both individually and in any desired combination.

### REFERENCE SIGNS

10 airbag
11 first/lower/outer fabric layer
12 second/middle fabric layer
13 third/upper/inner fabric layer
14 first (outer) airbag chamber
14₁ first (outer) longitudinal airbag chamber
14₂ first (outer) longitudinal airbag chamber
14₃ first (outer) longitudinal airbag chamber
14_{BK} First (outer) longitudinal airbag chamber (longitudinal bridge chamber)
16₁ first (inner) longitudinal airbag chambers
16 first (inner) longitudinal airbag chambers
16₃ first (inner) longitudinal airbag chambers
16₄ first (inner) longitudinal airbag chambers
16₅ first (inner) longitudinal airbag chambers
16₆first (inner) longitudinal airbag chambers
16₇ first (inner) longitudinal airbag chambers
16₈ first (inner) longitudinal airbag chambers
18 first generator mouth
20 second generator mouth
22 edge or peripheral woven seam
24 second airbag chamber
24₁ second longitudinal airbag chambers
24₂ second longitudinal airbag chambers
24₃ second longitudinal airbag chambers
24₄ second longitudinal airbag chambers
24_{WN} woven seam between second longitudinal airbag chambers
24_{OWN} woven seam between upper second longitudinal airbag chambers
24₁₀ second upper longitudinal airbag chambers
24₂₀ second upper longitudinal airbag chambers
24₃₀ second upper longitudinal airbag chambers
24₄₀ second upper longitudinal airbag chambers
24₁₂ᵤ second lower longitudinal airbag chambers
24₃₄ᵤ second lower longitudinal airbag chambers
ÜB transition region
S weft direction
K warp direction
WN woven seam
FN fixing seam
ÜAₒᵤₜₑᵣ outer overlapping portion
ÜAᵢₙₙₑᵣ inner overlapping portion

1. An airbag, preferably a one-piece woven (OPW) airbag, which is configured to be set from an uninflated state to an inflated state by an inflation operation to protect an occupant of a vehicle,
wherein the airbag has at least two fabric layers, preferably two fabric layers in certain regions and/or three fabric layers in certain regions, which are joined together in such a way that at least a first airbag chamber and a second airbag chamber being separate from the first airbag chamber are formed,
wherein the fabric layers are further joined together in such a way that
the first airbag chamber, preferably formed as a three-layer chamber, and the second airbag chamber, preferably formed as a two-layer or three-layer chamber, can be set independently of each another from the uninflated state thereof into the inflated state thereof, respectively, and
the first airbag chamber, starting from its uninflated state, curves outwardly during a first inflation operation of the first airbag chamber and/or forms a tubular shape with an oval or circular cross-section at least in portions in the inflated state of the first airbag chamber, and thereby an overlapping portion (ÜAₒᵤₜₑᵣ), preferably an outer overlapping portion, of the second airbag chamber in the uninflated state thereof or in the inflated state thereof overlaps, preferably radially overlaps, an overlapping portion (ÜAᵢₙₙₑᵣ), preferably an inner overlapping portion, of the first airbag chamber.

2. The airbag according to claim 1, wherein the fabric layers are joined together in such a way that the outer overlapping portion (ÜAₒᵤₜₑᵣ) of the second airbag chamber in the uninflated state radially overlaps with the inner overlapping portion (ÜAᵢₙₙₑᵣ) of the first airbag chamber in the inflated state and/or curves outwardly during a second inflation operation of the second airbag chamber or extends along the inner overlapping portion (ÜAᵢₙₙₑᵣ) of the first airbag chamber in the inflated state and thereby radially overlaps with the inner overlapping portion (ÜAᵢₙₙₑᵣ) of the first airbag chamber in the inflated state and/or forms a radial outer tube wall portion or hollow cylinder wall portion with respect to the radial inner overlapping portion (ÜAᵢₙₙₑᵣ) of the first airbag chamber in the inflated state.

3. The airbag according to claim 1, wherein the first airbag chamber has a plurality of interconnected first longitudinal airbag chambers with respective first airbag chamber volumes which, in the inflated state, are arranged next to one another in the circumferential direction and/or extend axially, transversely, obliquely or helically, and/or the second airbag chamber has a single longitudinal airbag chamber or a plurality of interconnected second longitudinal airbag chambers with respective second airbag chamber volumes, which, in the inflated state, are arranged next to one another in the circumferential direction and/or extend axially, transversely, obliquely or helically and/or the plurality of the first longitudinal airbag chambers is arranged in the circumferential direction next to the single longitudinal airbag chamber or the plurality of the second longitudinal airbag chambers.

4. The airbag according to claim 3, wherein the first airbag chamber volumes of the first longitudinal airbag chambers are formed smaller than, equal to or larger than the second airbag chamber volumes of the second longitudinal airbag chambers.

5. The airbag according to claim 3, wherein the first longitudinal airbag chambers and/or the second longitudinal airbag chambers are formed tubular or at least in portions hollow cylindrical or in the shape of an elliptical hollow cylinder.

6. The airbag according to claim 3, wherein the airbag comprises three fabric layers at least in portions, namely a first fabric layer, a third fabric layer and a second fabric layer arranged therebetween,
wherein the three fabric layers are woven together so that in a region (LKB) forming the first airbag chamber, first longitudinal airbag chambers extending in the axial direction and radially offset from one another are formed between the first fabric layer and the second fabric layer and the third fabric layer and the second fabric layer and/or in a region forming the second airbag chamber, second longitudinal airbag chambers extending in the axial direction and radially offset from one another are formed between the first fabric layer and the second fabric layer and the third fabric layer and the second fabric layer, which, during their respective inflation operations, cause an outward curvature at least in portions.

7. The airbag according to claim 3, wherein the airbag comprises three fabric layers at least in portions, namely a first fabric layer, a third fabric layer and a second fabric layer arranged therebetween,
wherein the three fabric layers are woven together so that in a region (LKB) forming the first airbag chamber, first longitudinal airbag chambers extending in the axial direction and radially offset relative to one another are formed between the first fabric layer and the second fabric layer and the third fabric layer and the second fabric layer, while only two fabric layers in a region forming the second airbag chamber form one or more second longitudinal airbag chambers extending in the axial direction between the first fabric layer and the third fabric layer.

8. The airbag according to claim 1, wherein the first airbag chamber is connected to a region which forms a first generator mouth for receiving a first gas generator or a first connection region for connecting a first gas generator, and the second airbag chamber is connected to a region which forms a second generator mouth for receiving a second gas generator, the second generator mouth being separate from the first generator mouth, or a second connection region for connecting a second gas generator, so that the first airbag chamber and the second airbag chamber can be inflated independently of one another via their respective first or second gas generator.

9. The airbag according to-one of the preceding claims claim 1, wherein the airbag is formed as an OPW airbag with warp threads and weft threads woven into the woven fabric layers,
wherein the warp threads and weft threads are woven together in such a way that the airbag (10) has a first partial region (ETB) and a second partial region (ZTB) as well as a region (LKB) forming the first airbag chamber (14), wherein the first partial region (ETB) is arranged between the region (LKB) forming the first airbag chamber (14) and the second sub-region (ZTB),
wherein the warp threads and weft threads in the second partial region (ZTB) are woven together in such a way that the second partial region (ZTB) has at least one generator mouth for receiving a gas generator for filling the airbag or a connection for connecting a generator and is configured in two layers,
wherein the warp threads and weft threads in the region (LKB) forming the first airbag chamber are woven together in such a way that the region (LKB) forming the first airbag chamber has the plurality of first longitudinal airbag chambers and is configured in three layers, and
wherein the warp threads and weft threads of the second fabric layer emerge from the second fabric layer in the first partial region (ETB) and float completely between the first fabric layer and the third fabric layer and are incorporated into the first fabric layer and/or into the third fabric layer in the second partial region (ZTB).

10. An airbag arrangement comprising:
an airbag according to claim 1, and
at least two gas generators that can be activated independently of each other,
wherein a first generator of the two gas generators is received or connected in the first generator mouth or the first connection region of the first airbag chamber and a second generator of the two gas generators is received or connected in the second generator mouth or the second connection region of the second airbag chamber.

11. An airbag deployment apparatus for deploying an airbag comprising a control apparatus and an airbag arrangement according to claim 10, wherein the control apparatus is configured to activate the first generator to fill the first air chamber and is further configured to activate the second generator to fill the second air chamber when the first generator has already been activated and a predetermined condition has been met, preferably a predetermined time has elapsed.

12. A method of deploying an airbag arrangement according to claim 10, comprising the following steps:
activating the first generator to fill the first air chamber of the airbag, and activating the second generator to fill the second air chamber of the airbag, at the same time or after the first generator has already been activated.
